(19) United States
(12) Patent Application Publication
(10) Pub. No.: US 2006/0151758 A1
(43) Pub. Date: Jul. 13, 2006

(54) Fire resistant intumescent thermoplastic or thermoset compositions

(76) Inventor: Jose Reyes, Newtown, PA (US)

Correspondence Address: FISH & RICHARDSON P.C., P.O. BOX 1022, MINNEAPOLIS, MN, 55440-1022, US

(21) Appl. No.: 10/534,718

(22) PCT Filed: Nov. 13, 2003
(86) PCT No.: PCT/US03/36696

§ 371 Date: Jan. 13, 2006

Related U.S. Application Data
(60) Provisional application No. 60/426,066, filed on Nov. 13, 2002.

(51) Int. Cl. C09K 21/00

(52) U.S. Cl. 252/601

(57) ABSTRACT

Flame retardant plastic resin blends comprise an intumescent flame retardant and at least one plastic resin. Engineering resin blends comprise an intumescent flame retardant and at least one engineering resin. Thermoset resin blends comprise an intumescent flame retardant and at least one thermoset resin. The plastic resin blends and the engineering resin blends are non-halogen. The thermoset resin blends are substantially non-halogen.

### CROSS-REFERENCE TO RELATED APPLICATION

This application claims the benefit of U.S. Provisional Application No. 60/426,066, filed Nov. 13, 2002, the entire disclosure of which is incorporated herein by reference.

### FIELD OF THE INVENTION

The present invention relates to compositions containing an intumescent flame retardant and a plastic resin, an engineering resin and/or a thermosetting resin, and methods for making the compositions.

### BACKGROUND

Fire-resistant or flame-retardant, polymeric materials are used in connection with a variety of applications. Example applications include use in wire and cable jacketing and insulation, and injection molding. Wire and cable applications for the fire-resistant polymeric materials are diverse, ranging from copper to fiber, plenum, riser, and other telecommunications and electrical applications.

Flame retardancy and/or fire resistance is particularly important in plenum cable and similar applications. Plenum cables are the electrical and/or telecommunication cables (or wires) that are installed in environmental airspaces in the interior of many commercial and residential buildings. Plenum cables must be electrically insulated for a variety of reasons and, thus, are coated, sheathed, encapsulated, or otherwise equipped with polymeric material or plastic around a conductive portion of the cable. Plenum cables are generally installed and sealed in ceilings, floors, and walls connected via shafts and raceways which facilitate transport of flame, smoke, and toxic and corrosive gases throughout a building. As such, they can present a major hazard to people and equipment in the event of a fire.

To limit the spread of flames and combustion of gases from burning wires and cables in buildings, the National Electrical Code (NEC) has set requirements and standards for the materials used in producing the wires and cables in these buildings. Attempts to meet these standards with polymeric materials generally involve adding compounds or materials to the base polymer(s) or otherwise modifying its properties. Such additions or modifications, however, generally are accompanied by tradeoffs in the other properties of the polymeric material, such as its electrical or insulative characteristics, or suffer from various other drawbacks or disadvantages.

One approach has been to use fluorocarbon polymeric materials, such as fluorinated ethylene propylene, to insulate and jacket plenum cables. The fluorocarbon polymeric materials generate low smoke and are flame retardant; however, the fluorocarbon polymeric materials are expensive and contain fluorine. As such, when the fluoroplastic materials are heated to high temperatures, for example, during a fire, they release a complex series of potentially toxic, harmful, and undesirable fluorine-containing gases. One such gas is hydrogen fluoride, which is known for its corrosive action on metals and glass fibers.

Because of the undesirable toxins associated with heated fluoroplastic materials, alternative polymeric materials having attractive physical insulating characteristics, flame resistance, and low smoke properties have been sought. For example, polyvinyl chloride (PVC) has been developed for use in plenum cable construction. PVC compositions that enhance the fire-resistance and low-smoke properties of the separate insulation and jacketing layers found in the plenum cables and that improve the flexibility characteristics of the plenum cables have been developed. Although these PVC compounds are “low smoke,” they still suffer from various drawbacks and disadvantages. For example, PVC jackets generally produce by-product combination gases that are emitted when the PVC jacket is heated to high temperatures. The first step thermal decomposition of PVC produces substantial quantities (>50% by weight) of the toxic, strongly corrosive acid, hydrogen chloride. PVC jackets also do not generally provide sufficient thermal protection to the wires or cables covered.

Serving as an additional risk, plasticizers used to increase flexibility of PVC for plenum cables generally increase the flammability of the PVC compositions. While the increase in flammability can be reduced somewhat through the use of various flame retardants, the addition of the flame retardants to other processing additives in the plasticized PVC compositions often undesirably increases the amount of smoke produced by the burning PVC compositions.

Attempts to overcome disadvantages of excess smoke from cable insulation, again, have achieved mixed results at best. For example, non-halogenated polyolefins (NHPOs), while avoiding some of the drawbacks of PVC-based solutions, have cost and other disadvantages. The non-halogen additive approach reduces electrical performance. Because significant flame retardancy is only accomplished through the addition of high levels of metal salts, such as aluminum and magnesium hydrates, the resultant formulated products not only have higher costs, but also process more slowly. Additionally, they have somewhat reduced physical and mechanical properties when compared with the original non-flame retardant base resin. Still further, such metal salts have relatively high specific gravities and thus increase overall weight, a drawback particularly in aerospace, mass transit, or other applications where lower weight is important.

Furthermore, the addition of halogens to polyolefin resins generally results in reduced electrical performance of the material, increased smoke and release of toxic and corrosive combustion gases.

In view of the above, the addition of flame retardants to polyolefins generally results in certain limitations to their applications as insulating materials, such as uses in low voltage electrical power, voice or data transmission, or intermediate level flame retardant jackets.

In addition to the materials discussed above, thermoset materials have also been used for their insulative properties, such as to insulate and jacket plenum cables. Thermoset materials typically are made from organic polymer resins and may contain a number of additives. Once cured or crosslinked, thermosets form compositions which are not readily re-melted upon exposure to high temperatures. These materials have excellent properties such as thermal performance, tensile properties, light weight, and corrosion resistance.

Some major drawbacks, however, to the use of thermoset resins are their poor flame resistance and smoke performance. While halogen materials such as brominated compounds have been used in the art to retard fire, the use of halogens creates large amounts of corrosive and toxic smoke. When traditional non-halogen flame retardants have been used, deleterious effects on cure, flow behavior and cost have been experienced. For example, when metal hydrates such as aluminum trihydrate or magnesium hydroxide have been used to suppress smoke or resist burning, the high concentrations required for efficacy negatively affect many of the thermoset resins' physical and rheological properties.

One method for improving the flame retardancy of thermoset resins is to incorporate additives suitable for imparting flame retardancy. Phosphorus-based non-halogen flame retardant products are of interest but they are not without their limitations. Generally, the interaction between a phosphorous-based flame retardant and thermoset curable resin leads to antagonistic interactions. In some cases the thermoset resin may not even cure. To add to the complex nature of proper flame retardant selection, it is often desirable to have the flame retardant not only impart flame retardancy to the thermoset composition but also to suppress smoke.

Additionally, it is often desirable to have powder flame retardants in pellet, crumb, flake, chip or other similar form that is non-powdery. Such non-powdery flame retardants are generally in concentrated form. Concentrates are when a large concentration of additives are combined and then later diluted to achieve desired additive levels. Concentrates mitigate dusting in large commercial factories producing flame retarded plastic articles or cables. However, non-halogen flame retardants have not been available in concentrate form at high efficient flame retardant concentrations, in the manner that halogen flame retardants, such as decabromodiphenyl oxide, have.

Thus, there is a need for a plastic and/or engineering and/or thermoset resin composition that has fire-resistant and low-smoke producing properties that can be used in a wide variety of wire and cable applications as well as injection molding applications, and that does not suffer from the drawbacks of prior compositions.

In one embodiment, a plastic resin blend comprises an intumescent flame retardant and at least one plastic resin.

In an alternate embodiment, an engineering resin blend comprises an intumescent flame retardant and at least one engineering resin.

In another alternate embodiment, a thermoset resin blend comprises an intumescent flame retardant and at least one thermoset resin.

The plastic, engineering and/or thermoset resin blends can be used for many applications. One application of the resin blends is for wire and cable insulation and jacketing. Plenum cable, fiber optic cable, copper cable, telecommunication cable and video cable are just a few of the several types of cables on which the invention can be utilized. Another application of the resin blends is injection molding.

### DETAILED DESCRIPTION

The invention will now be described by reference to the following detailed description of preferred embodiments.

The present invention relates to compositions formed from the combination of an intumescent specialty chemical incorporated into a plastic resin, such as, but not limited to, a polyolefin, and/or an engineering resin, such as, but not limited to, nylon, nylon 6 and/or 6/6, poly(butylene terephthalate), poly(ethylene terephthalate), acrylonitrile butadiene styrene (ABS), nylon 11, nylon 12, polycarbonate, aromatic polyamide and blends thereof, such as, but not limited to, ABS/polycarbonate, and/or a thermoset resin, such as, but not limited to, polyesters, polyolefins, epoxies, vinyl esters, alkyl polyesters, melamine isocyanurates, polyurethanes including, but not limited to, their foams, phenolic resins, phenylene-based resins, isophthalic and orthophthalic unsaturated polyesters, vinyl ester resins, epoxy resins, polyureas, polyurethanes and blends thereof. These compositions may be formed by the intimate mixing of the intumescent chemical with the plastic or engineering or thermoset resin. Members of the polyolefin family are: polypropylene, thermoplastic elastomers and polyethylene. Many subset plastic materials within each one of these members of the polyolefin family exist. For example, within polypropylene, there are homopolymer polypropylene, high impact co-polymer polypropylene, random co-polymer polypropylene, atactic polypropylene, crosslinked polypropylene (XLPP), and many others. Many members of the polyethylene family also exist. For example, within the polyethylene family are very low density polyethylene (VLDPE), low density polyethylene (LDPE), medium density polyethylene (MDPE), high density polyethylene (HDPE), linear low density polyethylene (LLDPE), crosslinked polyethylene (XLPE), and ethylene/vinyl acetate copolymer (EVA). Similarly, thermoplastic elastomers may be based on polypropylene or polyethylene backbones and may further contain dispersed rubber domains which are themselves either thermoplastic or thermoset (e.g. dynamically vulcanized).

The invention also relates to heat-resistant, non-halogen-containing, thermoplastic or thermoset polyolefin blends which are useful in wire and cable coatings, extruded profiles, sheets, foams, films or injection molded parts, as well as elastomeric thermoplastic polyolefin blends which are useful in injection molded parts. These blends generally are formed by combining an intumescent flame retardant with at least one polyolefin. Polymer blends according to the present invention can be formed in wire and cable coatings, extruded profiles, sheets, foams, films or injection molded parts which have many properties comparable or better than PVC containing blends, but with better resistance to heat than a polyolefin by itself. Alternatively, an engineering resin can be substituted for or combined with the polyolefin depending on the use of the thermoplastic engineering resin blend. For example, nylon can be utilized instead of or in combination with a polyolefin for use in sheets, films, or injection molded parts.

Unless otherwise stated, percentage weight ranges for each of the components in the composition of the present invention are calculated exclusive of any additives which may be present.

The plastic resin used in the present invention is preferably a polyolefin selected from the group consisting of (a) polypropylene homopolymer, (b) polypropylene copolymer, (c) ethylene propylene diene monomer (EPDM), (d) maleated propylene diene monomer (m-EPDM), (e) ethylene-polypropylene copolymer, (f) maleated ethylene-polypropylene copolymer (m-EP copolymers), (g) a thermoplastic elastomer, (h) a thermoplastic rubber, (i) ethylene/vinyl acetate copolymer (EVA), (j) poly(4-methyl-1-pentene) homopolymer, (k) poly(4-methyl-1-pentene/1-decene) copolymer, (l) very low density polyethylene (VLDPE), (m) low density polyethylene (LDPE), (n) medium density polyethylene (MDPE), (o) high density polyethylene (HDPE), (p) linear low density polyethylene (LLDPE), (q) crosslinked polyethylene (XLPE), and (r) blends thereof. Examples of polypropylenes are Equistar® PP 1610 PF and Basell® SE 191 and examples of thermoplastic rubbers are those in the Kraton® family made by Kraton Polymers. An example of VLDPE is Exact® 3022, made by Exxon Mobil Chemical, which has a density of 0.905 and a melt index of 9 g/10 min. Poly(4-methyl-1-pentene) is a polymer of 4-methylpentene-1 which is similar to polypropylene but has an isobutyl group in place of the methyl group on alternate carbon atoms. An example grade of 4-methylpentene-1 is ‘TPX’® from Mitsui Petrochemicals Ltd. Any grade polypropylene mixed with a co-polymer material such as, but not limited to, ethylene can be used in the present invention. The polypropylenes tested were BP6015 from B.P. Amoco Chemical Company and Petrothene® (Equistar® PP 1610-PF). The polypropylene or polyethylene preferably comprises approximately 10 to 85 percent by weight of the composition of the present invention, more preferably approximately 50 to 75 percent by weight. Still more preferably, the polypropylene or polyethylene comprises approximately 51 percent by weight when used in combination with another polyolefin.

The thermoset resins suitable for the invention is preferably selected from the group consisting of (a) polyesters, (b) polyolefins, (c) epoxies, (d) vinyl esters, (e) alkyl polyesters, (f) melamine isocyanurates, (g) polyurethanes including, but not limited to, their foams, (h) polyureas, (i) phenolic resins, (j) phenylene-based resins, (k) isophthalic unsaturated polyesters, (l) orthophthalic unsaturated polyesters, and (m) blends thereof. Examples of curable thermoset reins include: Dow Chemical's DERAKANE® 411-350 epoxy vinyl ester resin containing between approximately 30-60% styrene monomer and approximately 40-70% vinyl ester resins; AOC's VIPEL® F017 elastomeric epoxy vinyl ester resin, VIPEL® F457 polyethylene terephthalic, two stage, unsaturated polyester resins, VIPEL® F701 isophthalic polyester resin; a polyurethane foam comprising, at a minimum, (a) a polyether polyol containing an average of more than two hydroxyl groups per molecule, (b) an organic polyisocyanate such as, but not limited to, toluene diisocyante, (c) at least one catalyst, such as, but not limited to, an amine like triethylene diamine, bis(2-dimethylaminoethyl)ether, (d) water, (e) a surfactant, and (f) an inert gas; polyethylenes such as, but not limited to, ethylene vinyl acetate manufactured by Dupont and sold as Elvax®, such as, but not limited to, Elvax 240 which may cured into crosslinked polyethylene (XLPE).

The intumescent flame retardant is preferably selected from the group consisting of activated melamine pyrophosphates, activated melamine polyphosphates, activated ethylene diamine phosphate, activated ammonium polyphosphate, melamine, melamine phosphate, unactivated melamine pyrophosphates, unactivated melamine polyphosphate, melamine cyanurates and blends thereof. A preferred ratio of intumescent is 80:20 activated ethylene diamine phosphate to melamine phosphate. Examples of activated phosphate blends are Intumax AC2, Intumax AC3 WM, Intumax AC3, and Intumax M, all manufactured by Broadview Technologies. Intumax products are free flowing white powders with nominal particle sizes preferably in the range of 3-20 microns, more preferably in the range of 3-5 microns. They have a high purity of 98% or higher, possess outstanding char forming capabilities, and have a specific gravity of approximately 1.2. Additionally, Intumax AC3 WM contains activated ethylene diamine phosphate and melamine phosphate.

When used for a plastic and/or engineering resin, the intumescent flame retardant preferably comprises approximately 10 to 50 percent by weight of the composition of the present invention, more preferably approximately 25 to 35 percent by weight. Still more preferably, the intumescent flame retardant comprises approximately 33 percent by weight for cable applications and approximately 10 to 25 percent for injection molding applications.

When used for a thermoset resin, the intumescent flame retardant may be employed at a substantially broad range because even at very low levels the intumescent flame retardant assists in smoke suppression performance. The intumescent flame retardant preferably comprises about 0 to 50 percent by weight of the composition of the present invention, more preferably about 5 to 25 percent by weight, and most preferably about 15 to 20 percent by weight.

When concentrates are desired, the intumescent flame retardant comprises approximately 30 to 95 percent by weight of the plastic, engineering and/or thermoset resin blend. Surprisingly and unexpectedly, the invention of activated phosphates, such as those described herein, and polyolefin resins combine to form high concentrates suitable for use in plastics.

When making a cable compound, co-polyolefins (defined as a blending resin of the polyolefin family) blended with polypropylene or polyethylene achieve the targeted properties discussed below.

Other co-polyolefin(s) to be blended with the polypropylene or polyethylene will be chosen according to whether heat performance or elastomeric properties are more important for the end use of the composition, as will be known to one skilled in the art. For example, polypropylene homopolymer is often preferred where heat performance is most important, and very low density polyethylene is often preferred where elastomeric characteristics are most important. Linear low density polyethylene, high density polyethylene, medium density polyethylene, low density polyethylene, crosslinked polyethylene and ethylene-propylene co-polymer are generally used for end-uses requiring heat performance or elastomeric characteristics that are not extreme.

The terms “low density polyethylene” and “linear low density polyethylene” include co-polymers of ethylene and other alpha-olefins such as, but not limited to, 1-butene, 1-hexene, and 1-octene. The process for producing very low density polyethylene, linear low density polyethylene, high density polyethylene, low density polyethylene, crosslinked polyethylene and ethylene-propylene co-polymer are well known in the art and commercial grades of these polyolefins are available. The co-polyolefin component for blending with polypropylene preferably comprises 13.5 percent of the composition for wire and cable applications and from 0-80% for injection molding or sheet applications.

In addition to its polymer components, the composition of the present invention can be blended with other additives including, but not limited to, hindered phenolic stabilizers like tetrakis(methylene (3,5-di-tert-butyl-4 hydroxyhydrocinnamate))methane (e.g., Ciba Specialty Chemicals Irganox 1010), acid scavengers and hydrotalcites (e.g., DHT 4A from Kyowa Chemicals), endothermic agents such as, but not limited to, magnesium hydroxide (e.g., FR-20 from Dead Sea Bromine Group), zinc borate and the like, UV absorbers from the benzophenone family, nanoclays, nanomaterials, fillers, fiberglass, metallic fillers, colorants and blends thereof. For thermoset resins, the other additives may include, without limitation, curing agents, blowing agents, heat stabilizers, light stabilizers, plasticizers, accelerators, pigments, preservatives, ultraviolet light stabilizers, fillers, colorants, antioxidants, antistatic agents, viscosity modifiers, and other materials well known to those skilled in the art.

These other additives are present in amounts suitable for the particular application. For those applications discussed herein, the additives preferably comprise up to approximately 75 percent of the total composition based on polymer components plus additives (the polymer components being present in amounts with respect to each other in the proportions specified above); more preferably, the additives comprise approximately 0 to 60 weight percent of the total composition. Still more preferably, the additives comprise approximately 0 to 40 weight percent of the total composition.

Both reinforcing and non-reinforcing fillers and agents may be added, especially for injection molding applications, to improve dimensional stability, stiffness, color, nucleation and mechanical properties such as tensile strength and flexural modulus. Examples of such fillers and agents well known in the art are fiberglass, talc, mica, titanium dioxide, glass spheres, carbonates, and silica.

One skilled in the art knows that the use of various additional additives for thermoset resins, such as, but not limited to, unsaturated polyesters or vinyl ester resins, can be utilized to further improve the properties of the thermoset composition. These additional additives include, but are not limited to, glass fiber for reinforcement. The addition of glass fiber may be incorporated at a level of about 5 to 60 percent by weight of the composition, and preferably about 10 to 40 percent by weight.

The blends of the invention are prepared by mixing the polymeric ingredients and optional additives by use of conventional masticating equipment, for example, a rubber meld, Brabender mixer, Banbury mixer, Buss-co kneader, Farrel continuous mixer, twin screw continuous mixer, or any other suitable mixing apparatus. Mixing time should be sufficient to obtain homogeneous blends and reaction between the polypropylene, activated phosphate, and thermoplastic elastomer. Satisfactory mixing time is dependent upon the time of the mixing equipment (sheer intensity). Typically, mixing times of about 3 to 5 minutes are satisfactory on a batch mixer, while 1 to 2 minutes are satisfactory on a continuous mixer. If the polymer blend is obviously non-homogeneous, additional mixing is required.

In sheet extrusion, the blended resins are modified to have more of an elastomeric nature. For injection molding, a wide range of desired properties exists, and the blends of polypropylene and co-polyolefins will vary significantly.

UL94 V standard test procedures were used when testing compression molded plastics containing compounds of the present invention. The specimens were tested per thickness and the results are found in the tables below. All of the specimens were tested after conditioning 48 hours at 23° Celsius and 50% RH. Each specimen was mounted with its long axis vertical and supported such that its lower end was ⅜″ above a Bunsen burner tube. Blue ¾″ high flame was applied to the center of the lower edge of the specimen for 10 seconds. If burning ceased within 30 seconds, the flame was re-applied for an additional 10 seconds. If the specimen dripped particles, the particles were allowed to fall onto a layer of untreated surgical cotton placed 12″ below the specimen.

The invention can be further understood by the following examples set forth in the tables and examples below in which parts and percentages are by weight and temperatures are in degrees Celsius unless otherwise noted.

TABLE 1

| Ingredients (percent) | Composition 1 | Composition 2 | Composition 3 | Composition 4 |
|---|---|---|---|---|
| Equistar PP 1610 PF | 74 | 66 | 74 | 66 |
| Intumax AC3 | 25 | 33 | — | — |
| Intumax AC3 WM | — | — | 25 | 33 |
| Irganox 1010 | 0.5 | 0.5 | 0.5 | 0.5 |
| DHT-4A | 0.5 | 0.5 | 0.5 | 0.5 |
| Total | 100 | 100 | 100 | 100 |

UL94 V Screening @ 1/16″ Compression Molded Specimens

| | |
|---|---|
| Projected UL94 Rating | V-O |
| Flame Date for 48 hours@23° C., 50% | |
| RH | |
| Afterflame Time After 1st flame (sec) | 0-1 |
| range | |
| Afterflame Time After 2nd flame (sec) | 0-2 |
| range | |
| 2nd Afterflame plus Afterglow (sec) | 0-2 |
| range | |
| Total Afterflame Time for set of 5 (sec) | 6 |
| Drips | No |
| Ignites cotton | No |
| Burned to Clamp | No |

UL94 V Screening @ ⅛″ Compression Molded Specimens

| | | | | |
|---|---|---|---|---|
| Projected UL94 Rating | V-0 | — | V-0 | V-0 |
| Drips | No | — | No | No |
| Ignites cotton | No | — | No | No |
| Average Specific Gravity-ASTM D792 | — | — | 0.9981 | 1.0348 |
| Average Oxygen Index-ASTM | — | — | — | 35.3 |
| D2863(%) | | | | |

Tensile Properties - ASTM D638

| | | | | |
|---|---|---|---|---|
| Average Yield Strength (psi) | — | — | — | 2162 |
| Average Break Strength (psi) | — | — | — | 1797 |
| Average Elongation (%) | — | — | — | 8.42 |

TABLE 2

| Ingredients (percent) | Composition 1 |
|---|---|
| Equistar PP 1610 PF (Polypropylene) | 51.0 |
| Intumax AC3 WM (Activated Phosphate) | 33.0 |
| Kraton (Thermoplastic Elastomers) | 14.0 |
| Irganox 1010 (Stabilizer) | 0.5 |
| DHT-4A (Acid Scavenger) | 0.5 |
| TiPure R-103 (Titanium Dioxide) | 1.0 |
| Total | 100 |

Tensile Properties at ⅛″- ASTM D638

| | |
|---|---|
| Average Break Strength (psi) | 1948 |
| Average Elongation (%) | 327 |

UL94 V @ 1/16″ Injection Molded Specimens

| | |
|---|---|
| UL94 Rating | V-0 |
| Drips | No |
| Ignites cotton | No |
| Average Oxygen Index - ASTM D2863 (%) | 34 |

An elongation average of 8.42% was achieved when the invention comprised 66% polypropylene by weight (Composition 4). An 8.42% elongation value may be suitable for injection molding applications. In sharp contrast, when 51% by weight polypropylene, in combination with a co-polyolefin blending resin such as Kraton®, Engages made by DuPont Dow Elastomers, Petrothene® made by Equistar Chemicals, or combinations thereof, as used in Composition 1 of Table 2, was added to 33% by weight activated phosphate, the elongation increased from 8% to 327% without tensile strength decreasing; tensile strength unexpectedly increased as a result of the thermoplastic elastomer. Additionally, the flame properties were not diminished. Thus, favorable and unexpected properties in polypropylene (and polyolefin) blends are achieved.

Other favorable, unexpected results were obtained, as demonstrated by the tables above. The UL94 V rating tested very low addition levels of Intumax intumescent products. This is especially true when UL 94 was tested at ⅛ inch dimensions; levels as low as 15 to 25 percent are achievable. For example, levels at least as low as 15% are achievable.

The compositions of the invention demonstrate excellent properties for injection molding and wire and cable insulation and jacketing, as can be seen in the tensile properties. Unexpectedly, using low amounts of activated phosphate flame retardants Intumax AC3 and Intumax AC3 WM for injection molding applications achieved a UL94V-O rating. Also, Limiting Oxygen Index (LOI) response in the inventive composition was better than expected. Generally, non-flame retarded polyolefins have LOI values of approximately 19. In an LOI test, as measured by ASTM D-2863, a sample is tested to determine the percent concentration of oxygen required to support combustion. High LOI values are desirable because they are indicative of materials that are less susceptible to burning.

Additionally, the invention's electrical performance was not affected as in the prior art. The compositions of the invention also have very low smoke evolution. When burned, the inventive polyolefin does not suffer from the dripping behavior generally associated with the burning of the previously used plastics, which are notorious for dripping during burning.

Novel heat barrier properties were also obtained. Additionally, the intumescent forms a very stable foam insulation layer. As a result of the tensile strength and elasticity, the invention is easy to process into articles or to extrude. Furthermore, no corrosive acids (e.g., HBr or HCl) are released when the inventive polyolefin burns. This is an improvement over the prior compositions, such as brominated flame retardant or PVC cable and molding compounds. Moreover, unusually and unexpectedly low specific gravity to achieve outstanding flame resistant properties is achieved. Consequently, the cost of manufacturing the inventive polyolefin and subsequent use in producing articles of the invention are decreased.

The present invention is well suited to meet objectives in at least wire and cable, injection molded or extruded goods. Though numerous changes in components, quantities and the like may be made by those skilled in the art, these changes are within the scope and spirit of the invention. The following examples demonstrate the characteristics of the flame retardant compound and are not intended to be limitations of the formulas used for making the compound.

### EXAMPLE 1

### Effect of Rubber Level

The rubber level in the composition was varied to determine certain mechanical and flame properties. Compositions were compounded using a Brabender counter rotating twin screw extruder. The formulations were mixed for about 2 minutes total residence time in the extruder and processing temperatures of approximately 200° C. to 210° C. were used. The resulting strands were chopped into pellets for molding and testing. Relative amounts of rubber varied in each test. Results of the samples tested are shown below in Table 3.

TABLE 3
Rubber Levels

| Ingredients (percent) | Composition 1 | Composition 2 | Composition 3 |
|---|---|---|---|
| Copolymer | 55.0 | 58.0 | 61.5 |
| Polypropylene | | | |
| Equistar PP 1610-PF | | | |
| Intumescent Flame | 33.0 | 33.0 | 33 |
| Retardant | | | |
| Intumax AC3WM | | | |
| Rubber | 10.0 | 7.0 | 3.5 |
| Kraton G-4610 | | | |
| Stabilizer | 0.5 | 0.5 | 0.5 |
| Irganox 1010 | | | |
| Acid Scavenger | 0.5 | 0.5 | 0.5 |
| DHT-4A | | | |
| Titanium Dioxide | 1.0 | 1.0 | 1.0 |
| TiPure R-103 | | | |
| Total | 100 | 100 | 100 |

Oxygen Index Testing - ASTM D2863

| | | | |
|---|---|---|---|
| Average Oxygen Index | 36.6 | 38.2 | 38.8 |
| (%) | | | |

Tensile Properties - ASTM D638

| | | | |
|---|---|---|---|
| Average Yield | 1960 | 2290 | 2450 |
| Strength (psi) | | | |
| Average Break | 2140 | 2520 | 2510 |
| Strength (psi) | | | |
| Average Elongation | 330 | 410 | 410 |
| (%) | | | |

UL 94V Flammability - 1/16″ Injection Molded Specimens

| | | | |
|---|---|---|---|
| UL 94V Rating | V-0 | V-0 | V-0 |

The samples all demonstrated excellent performance for tensile strength, elongation and flammability as measured by UL 94 V testing. Although Composition 3 contained a low level of rubber, it demonstrated unexpectedly high elongation similar to Composition 1 which had a significantly higher rubber level. The oxygen index was very high for all three recipes.

### EXAMPLE 2

### Level of Intumescent Flame Retardant on Flame Performance

Polypropylene copolymer resin was compounded using the procedure in Example 1. Levels of Intumax AC3WM well below that shown in Table 3 were examined, except for the control composition (Composition 4 in Table 4 below), which had an Intumax AC3WM level of 35%.

The results are shown in Table 4 below.

TABLE 4
Intumescent Flame Retardant Level

| Ingredients | Composition | Composition | Composition | Composition |
|---|---|---|---|---|
| (percent) | 1 | 2 | 3 | 4 |
| Homopolymer | 80 | | | |
| Polypropylene | | | | |
| Copolymer | | 65.5 | 60.5 | 50.5 |
| Polypropylene | | | | |
| Intumax | 20 | 20 | 25 | 35 |
| AC3WM | | | | |
| Rubber | | 14 | 14 | 14 |
| Antioxidant | | 0.5 | 0.5 | 0.5 |
| Total | 100 | 100 | 100 | 100 |
| ⅛ inch | V-0 | V-1 | V-0 | V-0 |
| UL-94 V | | | | |
| Results | | | | |

Without flame retardant present, the polypropylene will burn and not meet a UL-94 rating of either V-0, V-1 or V-2. However, when lower levels of Intumax AC3WM were utilized, the composition unexpectedly continued to provide high flame retardancy performance when compared to that found in higher levels of activated intumescent flame retardants. In all cases, not one sample burned more than 60 seconds of total after flame time. None of the samples dripped plastic material during burning which was unexpected considering the low levels of intumescent flame retardant used, especially in Composition 1 of Table 4.

### EXAMPLE 3

### Concentrate Form of Activated Intumescent Flame Retardants

Intumax AC3WM was mixed according to the recipe shown in Table 5. The concentrate, as illustrated in Composition 1, was prepared using a Farrell Continuous mixer with temperature settings of 315° F.-400° F. Letdown (i.e., dilution) of the concentrate was prepared by blending concentrate pellets with virgin copolymer polypropylene and virgin homopolymer polypropylene pellets, respectively.

TABLE 5
Concentrate Form of Activated Intumescent Flame Retardants

| | Composition 1 | Composition 2 | Composition 3 |
|---|---|---|---|
| Ingredients (percent) | Concentrate | Letdown | Letdown |
| Copolymer Polypropylene, Equistar PP 1610-PF | 16 | 66.7 | |
| Intumescent Flame Retardant AC3WM | 60.0 | | |
| Kraton G-4610 | 20.0 | | |
| Antioxidant | 1.0 | | |
| DHT-4A | 1.0 | | |
| TiPure R-103 | 2.0 | | |
| Intumax AC3 WM Concentrate (i.e. Recipe 1) | | 33.3 | 50 |
| Homopolymer Polypropylene BP 6015 PP | | | 50 |
| Total Percent of Recipe | 100 | 100 | 100 |
| Percent of AC3WM contributed to Respective | 60 | 20 | 30 |
| Recipe from Concentrate defined in Recipe 1 | | | |
| Average Oxygen Index (%) | | | 33.8 |
| Average Break Strength (psi) | | | 3180 |
| Average Elongation (%) | | 398 | 390 |
| UL 94V Rating ( 1/16 inch) | | V-0 | V-0 |
| Drips | | No | No |
| Ignites cotton | | No | No |

Results demonstrated that with in-situ mixing in the molding machine between virgin polypropylene pellets and concentrate pellets similar properties were achieved equivalent to if all the ingredients were extrusion compounded similar to that shown in Table 3 of Example 1. Excellent physical and flame properties were obtained following suitable letdown of the prepared concentrate. For example, the use of the concentrate letdown in an injection molding machine enabled a non-burning non-dripping compound that required only 20% of Intumax AC3WM (Composition 2). These unexpected results indicate that the compound offers the ability to produce flame retardant articles by blending a non-halogen flame retardant concentrate with polyolefin pellets instead of compounding all ingredients much like was done in Example 1. This example is illustrative and not limiting; the concentrate can also be produced in forms other than pellets and with other activated phosphates as described herein.

### EXAMPLE 4

### Polyolefin Resin Types

Polyolefin resin types besides copolymer polypropylene can be utilized. For instance, BP 6015 PP, a homopolymer polypropylene resin manufactured by B. P. Amoco Chemical Company, was used as shown in Table 5. This resin is characterized by melt flow rate of 0.5 grams per 10 minutes as measured per ASTM 1238. Elongation of the resin as produced by the manufacturer has a nominal elongation of approximately 100% as measured by ASTM D 638. Using this resin instead of the Equistar® PP 1610-PF produced an equivalent flame resistant UL-94V-0 rating without dripping as per the Equistar-based formulations shown in Tables 1-3. This is equivalent to the results obtained using Equistar® PP 1610-PF copolymer. Also, the composition dramatically increased the elongation of the unmodified BP 6015 PP.

Different resin types can also be utilized with oxidized polypropylene or polyethylene materials. Table 6 lists a different resin type made by Basell Polyolefins; however, any resin type with similar properties to the resin types described herein can be utilized. Oxidized polypropylene or oxidized polyethylene materials contain active oxygenated groups convertible to lactones, ionomers, etc. They can be blended with other polyolefins in the invention. Table 6 illustrates formulations using oxidized polypropylene in combination with copolymer polypropylene.

TABLE 6
Additional Polyolefin Resin Types

| Ingredients (percent) | Control | Composition 1 | Composition 2 |
|---|---|---|---|
| Petrothene PP 1610-PF | 51% | 46% | 41% |
| Kraton G4610 | 14% | 14% | 14% |
| Intumax AC-3WM | 33% | 33% | 33% |
| Antioxidant | 0.5% | 0.5% | 0.5% |
| Acid Scavenger | 0.5% | 0.5% | 0.5% |
| Titanium Dioxide | 1% | 1% | 1% |
| Basell Oxidized PP | 0% | 5% | 10% |
| XA007150-B | | | |
| Oxygen Index, % | 100% | 100% | 100% |
| | 31.9 | 34.3 | 35.0 |

The oxygen index results obtained with the blending of two polyolefins, such as oxidized polypropylene and copolymer resins, demonstrate an improvement in flame retardancy. The addition of oxygenated polypropylene illustrates a significant and unexpected improvement in flame retardancy.

This example illustrates the use of the invention with different resins for applications requiring outstanding flame resistant performance and high elongation polyolefin compositions, such as, but not limited to, wire and cable, injection molded articles and extruded goods. Those skilled in the art will recognize that the invention will also work with activated phosphates and polyethylene resins, including, but not limited to, high density polyethylene, linear low density polyethylene, medium density polyethylene, very low density polyethylene and crosslinked polyethylene.

### EXAMPLE 5

### Electrical Properties

Electrical properties are very important in certain applications, such as wire and cable and molded connectors. In such applications, very low dielectric properties are desired, especially at high frequencies. The dielectric constant and dissipation factor were measured at both 1 MHz and 2.5 GHz for Composition 1 in Table 2. Results are shown in Table 7.

TABLE 7
Electrical Properties

| | 1 MHz | 2.5 GHz |
|---|---|---|
| Dielectric Constant | 2.77 | 2.84 |
| Dissipation Factor | 0.0036 | 0.00232 |

These electrical properties exceed that of commercial grade low smoke PVC plastic insulation material used in plenum cable applications (e.g., dielectric constant=3.60 and dissipation factor=0.0176). These electrical properties are significant since the material of the present invention offers considerable advantages in cable or molded article design applications. The advantages include less smoke and toxins being produced upon burning and the article's maintaining its electrical conductivity even though it is flame retarded.

### EXAMPLE 6

### Resistance to Long Burn Times

A compression molded plaque of approximately 6″×6″×⅛″ thick was made using Composition 1 in Table 2. The plaque was suspended vertically. At the lower end of the plaque, a flame from a burner used in the UL-94 V-0 test was applied to one corner. The flame was applied for 30 minutes to determine flame sustaining properties. Various commercial tests such as UL-1666 and UL-910 require cable materials to withstand sustained flame application times. No flame growth was observed in the vertical direction upon removal of the flame. While the flame was applied, the flame did not reach the top edge of the plaque. Furthermore, during the entire test, no dripping was observed. The compound demonstrated excellent resistance to sustained flame application. Other polyolefin resins, such as polyethylene resins of various grades mentioned previously, can be used to obtain similar results in the compositions of the present invention.

### EXAMPLE 7

### Insulated Copper Wire

Fiber optic cable and copper cable can be used in various cable applications such as military, automotive, and any requiring UL-910 plenum rating. Underwriters Laboratories, “UL 910, Test for Flame Propagation and Smoke Density Values for Electrical and Optical-Fiber Cables Used in Spaces Transporting Environmental Air” (1995) is incorporated herein by reference and describes the test to obtain a UL-910 rating. As mentioned in Example 6, this test requires sustained burn times. UL-910 flame application requires that the article withstand sustained flame application for 20 minutes.

Copper wire of 24 gauge was extrusion coated using material defined in Recipe 1, Table 2 using a laboratory Brabender extrude mounted with a crosshead die. Temperatures were set on the extruder from about 155° C. to about 185° C. Insulation thickness from 0.018″ to 0.040″ was extruded onto the copper wire. The resulting coated insulated wire was then suspended vertically and a flame applied in the manner described in Example 6. After 30 minutes of the flame being applied to the end of the coated wire, the flame was removed. Total burn time was less than one minute upon removal of the flame. The insulation was self-extinguishing and flames did not spread to the other side of the approximately 12″ test wire sample. Only approximately 6″ of insulation actually burned while the rest of the cable insulation was undamaged during the 30 minute flame application. Those skilled in the art will recognize that the compositions illustrated in Tables 1 through 6 may also be utilized as jacketing and/or insulation material for cables. Furthermore, those skilled in the art will recognize that additional cable designs beyond single copper core coated wire are suitable for use by the invention. For example, jacketing covering a plurality of insulated conductors is another cable design that can be implemented. Generally, plenum cables have two or more pairs of insulated conductors contained within a common jacket. The invention is not limited to these cable and jacket designs; it is meant to cover any suitable amount of conductors, fiber optic strands, wires or cables that can be used in cable and jacket designs.

### EXAMPLE 8

### Steiner Tunnel Large Scale Testing

Plastic insulation material used in Example 5 was extruded into tape of 0.008″ to 0.014″ thick. The tape was tested according to the ASTM E-84 test, also known as the Steiner Tunnel test. The UL-910 test for plenum cable is a modified adaptation of the Steiner tunnel test. The Steiner test uses horizontal forced air draft. Steiner test results are significant when compared to the UL-910 test because the plenum space is used as a passage for forced air in handling systems in buildings. The plenum is also a location for cables. Thus, it is important that cables located in the plenum not have excessive flame spread or smoke, especially corrosive or toxic smoke.

Results of the extruded tape yielded a very low smoke index value of 150. No halogenated corrosive gasses were emitted from the cable of the present invention because the total composition contained no halogens.

### EXAMPLE 9

### Cone Calorimeter Tests

Cone calorimeter testing is becoming an important predictive way to test the fire safe nature of plastic materials. In fires, smoke is typically the lethal agent. Thus, non-toxic smoke is an important characteristic. The formulation of Example 8 was tested in cone calorimetry for smoke and heat release rate. Results showed that there was zero carbon monoxide emitted by the formulation. Furthermore, because the recipe contained zero halogens, there were no HBr, HCl or HF present. Very low heat release rate values after 300 seconds of testing showed a heat release rate of 75 kW per square meter. The discovery of zero carbon monoxide in the invention was an unexpected result.

### EXAMPLE 10

### Viscosity of Molten Compositions

The invention has excellent flow behavior relative to materials used in cable construction which are non-halogen flame retardant. It does not suffer from high viscosities because of the efficient utilization of the use of activated phosphates. Table 8 summarizes the viscosity measurements for Composition 1 of Table 2. Materials were tested using a capillary viscometer with a test temperature of 200° C.

TABLE 8
Capillary Viscosity at 200° C.

| | Viscosity (Pa-sec) |
|---|---|
| Shear rate (sec⁻¹) | Composition 1, Table 2 |
| 100 | 20,000 |
| 10,000 | 700 |

It is observed that the compound of Composition 1 of Table 2 has low viscosity measurements. For example, at a shear rate of 100 sec⁻¹ which is similar to extrusion applications, the compound has a viscosity of 20,000 Pa-sec. The composition tested does not contain any metal hydrates that would increase the compound's viscosity.

### EXAMPLE 11

### Surface Treated Intumescent Flame Retardants

Intumax AC3WM was surface treated with various surface agents and improved processability was observed. Composition 2 in Table 4 was compounded using a Brabender mixing bowl. The Composition 2 pellets were surface coated to 0.5% by weight (on the flame retardant) with LICA 38 supplied by Kenrich Chemicals. LICA 38 is a pyrophosphate surface agent. Upon melt compounding in the Brabender mixing chamber, good metal release and processability was observed.

Later, ribbon tapes were extruded using the material in Example 8 but with surface treated Intumax AC3WM flame retardant powder coated directly with LICA 38 at 0.5% by weight based on the flame retardant Excellent surface appearance was observed versus ribbons not containing the surface agent in the recipe or on the flame retardant. Ribbon samples were tested for tensile strength and elongation. The results were: tensile strength was 1790 psi and elongation was measured to be 450 percent for the compound described in Example 8.

Those skilled in the art will observe that other suitable surface coating agents are silicone and silanes, such as, but not limited to: (acryloxypropyl)trimethoxysilane, liquid silicone, vinyltrimethoxysilane, vinyltriethoxysilane, 3-mercaptopropyltrimethoxysilane and 3-aminopropyltriethoxysilane. Surface agent levels are not limited to 0.5% for effectiveness. In some instances, higher levels are beneficial, while in other applications, lower levels are beneficial and the surface agent levels needed will be readily apparent to one skilled in the art.

### EXAMPLE 12

### Color Pigment Addition

Outstanding flame retardant properties were observed by the incorporation of carbon black. This colorant is not only added for producing black plastic compositions but also because it imparts ultraviolet radiation protection. Samples of the recipe in Table 9 were compounded using the procedure described in Example 1. Test bars were injection molded into flame bars to determine oxygen index and UL 94 measurements.

TABLE 9
Black Colorant in Flame Retarded Polyolefin Composition

| Ingredients (percent) | Composition 1 |
|---|---|
| Copolymer Polypropylene, Equistar | 54.0 |
| PP 1610-PF | |
| Intumescent Flame Retardant AC3WM | 40.0 |
| Rubber, Kraton G-4610 | 3.5 |
| Antioxidant, Irganox 1010 | 0.5 |
| Acid Scavenger, DHT-4A | 0.5 |
| Carbon Black, Vulcan 9A32 | 1.5 |
| Total | 100 |
| Average Oxygen Index (%) | 41.0 |
| UL94V @ 1/16″ Injection Molded | |
| Projected UL94 Rating | V-0 |
| Drips | No |
| Ignites cotton | No |
| Average Specific Gravity | 1.10 |

Unexpectedly, an extraordinary high oxygen index was observed. It is unusual for polypropylene to demonstrate oxygen index values like the one shown in Table 9 and, accordingly, the polypropylene has increased flame retardancy.

### EXAMPLE 13

### Alternative Rubber for Low Temperature Impact Modification

Low temperature impact strength is very important for meeting various cable requirements. Low temperature impact strength testing for cable applications is called Brittleness Temperature and is measured using ASTM D2746. Both Kraton G-4610 and Engage 8180 were examined as suitable rubbers for brittleness temperature. Engage 8180 is a polyolefin elastomer based on ethylene-octene copolymer architecture. It has a density of 0.863 grams per cubic centimeter. Compositions were prepared as described in Example 1 using the Brabender twin screw extruder.

TABLE 10
Brittleness Temperature

| Ingredients (percent) | Compound 1 | Compound 2 |
|---|---|---|
| Copolymer Polypropylene, Equistar PP | 51.0 | 51.0 |
| 1610-PF | | |
| Intumescent Flame Retardant AC-3WM | 33.0 | 33.0 |
| Rubber, Engage 8180 | 14.0 | 0 |
| Rubber, Kraton G-4610 | 0 | 14.0 |
| Acid Scavenger, DHT-4A | 0.5 | 0.5 |
| Antioxidant, Irganox 1010 | 0.5 | 0.5 |
| Titanium Dioxide, TiPure R-103 | 1.0 | 1.0 |
| Total Percentage in Recipe | 100 | 100 |
| Average Oxygen Index (%) | 34.7 | 33.0 |
| UL94V @ 1/16″ Injection Molded | | |
| UL94 Rating | V-0 | V-0 |
| Drips | No | No |
| Ignites cotton | No | No |
| Brittleness Temperature, C | −37 | −40 |

Excellent low temperature brittleness impact strength was observed with both rubber types.

### EXAMPLE 14

### Preparation of Flame Retarded Vinyl Ester Resins

Vinyl ester thermosets were prepared. DERAKANE® 411-350 epoxy vinyl ester resin was used. A brominated bisphenol A type halogen containing epoxy vinyl ester resin was used as a control (DERAKANE® 510A-40). The following ingredients were mixed together in amounts shown in the Table 10 below: DERAKANE® 411-350, Norac Norox® MEKP (9% active oxygen), OMG 6% cobalt octoate, Buffalo Color N,N-Dimethylaniline (DMA), Intumax AC3WM, and Budit® 3127 unactivated ammonium polyphosphate.

Sample disks were cured at 80° C. for one hour. Following the curing process, a band saw was used to cut a strip from the center of the disk. The strips were then placed into a flame hood. Using a UL 94 vertical burn test burner, a flame was applied to each sample for 3 minutes. After removal of the flame, the burning process was timed until extinction of afterflame. Also, observations were made regarding the density of smoke.

TABLE 11
Non-Halogen Flame Retarded Vinyl Ester Composites

| | | | Composition 3 | | |
|---|---|---|---|---|---|
| (Parts per 100 Resin) | Composition 1 | Composition 2 | (Control) | Composition 4 | Composition 5 |
| Derakane 411-350 | 100 | 100 | | 100 | 100 |
| Derakane 510A-40 | | | 100 | | |
| AC3WM | 20 | 30 | | 10 | |
| Budit 3127 (APP) | | | | | 20 |
| MEKP | 1.25 | 1.25 | 1.25 | 1.25 | 1.25 |
| Co Nap 6% | 0.20 | 0.20 | 0.20 | 0.20 | 0.20 |
| DMA | 0.05 | 0.05 | 0.05 | 0.05 | 0.05 |

Post Cure

| | | | | | |
|---|---|---|---|---|---|
| 80° C. Cure | 1 hour | 1 hour | 1 hour | 1 hour | 1 hour |
| Cured | Yes | Yes | Yes | Yes | Minimally |

Burn Testing

| | | | | | |
|---|---|---|---|---|---|
| Flame Application (min) | 3 | 3 | 3 | 3 | 3 |
| Afterflame Burn time (sec) | 19 | 100 | 0 | >30 | >70 |
| Smoke Observation | Low | Moderate | Very Heavy | Moderate | Heavy |
| Contained Corrosive HBr | No | No | Yes | No | No |
| Gas? | | | | | |

During mixing of the ingredients, no deleterious effect on viscosity was observed relative to the control recipe. This was unexpected because the non-control recipes (Compositions 1, 2, 4) contained levels of powder activated intumescent flame retardant, not present in the Control composition (Composition 3). In this respect, the AC3WM does not behave like a traditional powdery additive. Next, the AC3WM flame retardant unexpectedly did not interfere with the curing process of the vinyl ester resin. This is significant because generally additives may interfere with curing performance of thermoset systems. While the Control composition showed very low flame time, large amounts of smoke was observed in the test chamber. The activated phosphate composition (Composition 1) performed considerably better than the non-activated ammonium polyphosphate (Composition 5) despite the use levels being equal for both (i.e. 20 phr). At 20 phr of the AC3WM, fast flame out time was observed with little smoke developing. Even for the case where the AC3WM was used at only 10 phr, the smoked developed was still lower than the Control composition.

Additionally, compositions comprising non-halogen intumescent flame retardants had lower smoke development than the Control composition. Also, the activated intumescent flame retardant AC3WM demonstrated excellent low smoke, and good low flame time relative to the bromine containing halogenated flame retarded vinyl ester resin and also against the unactivated phosphate (Composition 5). The unexpected nature of activated phosphates demonstrates unusual efficacy and enhanced fire safety.

Additional advantages and variations will be apparent to those skilled in the art, and those variations, as well as others which skill or fancy may suggest, are intended to be within the scope of the present invention, along with equivalents thereto, the invention being defined by the claims attended hereto.

1-73. (canceled)

74. A chemical resin blend comprising an activated intumescent flame retardant and at least one resin selected from the group consisting of a plastic resin, an engineering resin and a thermoset resin, wherein the chemical resin blend is non-dripping and has a rating of V-0 or V-1 based on UL94 test procedures

75. The chemical resin blend of claim 74, wherein the resin is a plastic resin.

76. The chemical resin blend of claim 74, wherein the resin is an engineering resin.

77. The chemical resin blend of claim 74, wherein the resin is a thermoset resin.

78. The chemical resin blend of claim 74, wherein the activated intumescent flame retardant comprises at least one component selected from the group consisting of:
(a) activated melamine pyrophosphate;
(b) activated melamine polyphosphate;
(c) activated ethylene diamine phosphate;
(d) activated ammonium polyphosphate; and
(e) blends of any of the components (a) through (d).

79. A cable made from the chemical resin blend of claim 74.

80. The cable of claim 79, wherein the cable is selected from the group consisting of plenum cable, fiber optic cable, copper cable, telecommunications cable, and video cable.

81. The cable of claim 80, wherein the resin is a plastic resin, the plastic resin being at least one polyolefin selected from the group consisting of:
(a) polypropylene homopolymer;
(b) polypropylene copolymer;
(c) ethylene propylene diene monomer (EPDM);
(d) maleated propylene diene monomer (m-EPDM);
(e) ethylene-polypropylene copolymer;
(f) maleated ethylene-polypropylene copolymer (m-EP copolymers);
(g) a thermoplastic elastomer;
(h) a thermoplastic rubber;
(i) ethylene/vinyl acetate copolymer (EVA);
(j) a poly(4-methyl-1-pentene) homopolymer;
(k) poly(4-methyl-1-pentene/1-decene) copolymer;
(l) very low density polyethylene (VLDPE);
(m) low density polyethylene (LDPE);
(n) medium density polyethylene (MDPE);
(o) high density polyethylene (HDPE);
(p) linear low density polyethylene (LLDPE);
(q) crosslinked polyethylene (XLPE);
(r) crosslinked polypropylene (XLPP); and
(s) blends of any of the components (a) through (r).

82. The cable of claim 80, wherein the resin is an engineering resin, the engineering resin being at least one component selected from the group consisting of:
(a) nylon;
(b) poly(butylene terephthalate);
(c) poly(ethylene terephthalate);
(d) acrylonitrile butadiene styrene (ABS);
(e) nylon 6;
(f) nylon 6/6;
(g) nylon 11;
(h) nylon 12;
(i) polycarbonate;
(j) aromatic polyamide; and
(k) blends of any of the components (a) through (j).

83. The cable of claim 80, wherein the resin is a thermoset resin, the thermoset resin being at least one component selected from the group consisting of:
(a) polyester;
(b) polyolefin;
(c) epoxy;
(d) vinyl ester;
(e) alkyl polyester;
(f) melamine isocyanurate;
(g) polyurethane;
(h) polyurea;
(i) phenolic resin;
(j) phenylene-based resin;
(k) isophthalic unsaturated polyester;
(l) orthophthalic unsaturated polyester; and
(m) blends of any of the components (a) through (l).

84. The cable of claim 80, wherein the activated intumescent flame retardant comprises at least one component selected from the group consisting of:
(a) activated melamine pyrophosphate;
(b) activated melamine polyphosphate;
(c) activated ethylene diamine phosphate;
(d) activated ammonium polyphosphate; and
(e) blends of any of the components (a) through (d).

85-92. (canceled)

93. The chemical resin blend of claim 78, wherein the activated intumescent flame retardant further comprises at least one component selected from the group consisting of:
(a) melamine;
(b) melamine phosphate;
(c) unactivated melamine pyrophosphate;
(d) unactivated melamine polyphosphate;
(e) melamine cyanurate; and
(f) blends of any of the components (a) through (e).

94-96. (canceled)

97. The cable of claim 84, wherein the activated intumescent flame retardant further comprises at least one component selected from the group consisting of:
(a) melamine;
(b) melamine phosphate;
(c) unactivated melamine pyrophosphate;
(d) unactivated melamine polyphosphate;
(e) melamine cyanurate; and
(f) blends of any of the components (a) through (e).

98. (canceled)

99. The chemical resin blend of claim 74, wherein the chemical resin blend is a concentrate.

100. The chemical resin blend of claim 99, wherein the activated intumescent flame retardant comprises approximately 50% to 95% by weight of the chemical resin blend.

101. The chemical resin blend of claim 75, wherein the plastic resin is at least one polyolefin selected from the group consisting of:
(a) polypropylene homopolymer;
(b) polypropylene copolymer;
(c) ethylene propylene diene monomer (EPDM);
(d) maleated propylene diene monomer (m-EPDM);
(e) ethylene-polypropylene copolymer;
(f) maleated ethylene-polypropylene copolymer (m-EP copolymers);
(g) a thermoplastic elastomer;
(h) a thermoplastic rubber;
(i) ethylene/vinyl acetate copolymer (EVA)
(j) a poly(4-methyl-1-pentene) homopolymer;
(k) poly(4-methyl-1-pentene/1-decene) copolymer;
(l) very low density polyethylene (VLDPE);
(m) low density polyethylene (LDPE);
(n) medium density polyethylene (MDPE);
(o) high density polyethylene (HDPE);
(p) linear low density polyethylene (LLDPE);
(q) crosslinked polyethylene (XLPE);
(r) crosslinked polypropylene (XLPP); and
(s) blends of any of the components (a) through (r)

102. The chemical resin blend of claim 76, wherein the engineering resin is at least one component selected from the group consisting of:
(a) nylon;
(b) poly(butylene terephthalate);
(c) poly(ethylene terephthalate);
(d) acrylonitrile butadiene styrene (ABS);
(e) nylon 6;
(f) nylon 6/6;
(g) nylon 11;
(h) nylon 12;
(i) polycarbonate;
(j) aromatic polyamide; and
(k) blends of any of the components (a) through (j).

103. The chemical resin blend of claim 77, wherein the thermoset resin is at least one component selected from the group consisting of:
(a) polyester;
(b) polyolefin;
(c) epoxy;
(d) vinyl ester;
(e) alkyl polyester;
(f) melamine isocyanurate;
(g) polyurethane;
(h) polyurea;
(i) phenolic resin;
(j) phenylene-based resin;
(k) isophthalic unsaturated polyester;
(l) orthophthalic unsaturated polyester; and
(m) blends of any of the components (a) through (l).

104. An article made from the chemical resin blend of claim 74.

105. The article of claim 104, wherein the activated intumescent flame retardant comprises at least one component selected from the group consisting of:
(a) activated melamine pyrophosphate;
(b) activated melamine polyphosphate;
(c) activated ethylene diamine phosphate;
(d) activated ammonium polyphosphate; and
(e) blends of any of the components (a) through (d).
